(19) United States
(12) Patent Application Publication
(10) Pub. No.: US 2012/0164479 A1
(43) Pub. Date: Jun. 28, 2012

(54) NICKEL SYSTEM

(75) Inventors: Andreas Prinz, Solingen (DE); Heiko Viecenz, Iserlohn (DE)

(73) Assignee: Herbert Schmidt GmbH & Co. KG, Solingen (DE)

(21) Appl. No.: 13/382,644

(22) PCT Filed: Jul. 7, 2010
(86) PCT No.: PCT/EP2010/059761

§ 371 Date: Mar. 15, 2012

(30) Foreign Application Priority Data
Jul. 7, 2009 (EP) 09164714.9

(51) Int. Cl. C25D 3/12; B32B 5/16; B32B 15/00; C25D 15/00

(52) U.S. Cl. 428/640; 205/109; 428/639

(57) ABSTRACT

A nickel electrolyte comprising:
nickel salts,
organic acid or salts thereof,
from 0.05 to 1 g/l of inorganic solid with a grain size (d50) of from 0.1 to 3 μm.

The present invention relates to a nickel electrolyte, and the use thereof.

Electrolytes for nickel electroplating are known to the skilled person in a wide variety of forms. For example, in surface finishing, components are provided with copper layers, which are in turn provided with two or three nickel layers and a chromium layer or other alloys. While the outer layers serve to improve the appearance of the component, the lower layers essentially serve for corrosion protection.

Typical fields of application include, for example, facings, strips, radiator grilles on automobiles.

The most frequently employed nickel electrolytes are based on the so-called Watt's electrolyte, which typically has the following composition:

| | |
|---|---|
| NiSO₄•7 H₂O | 240 to 310 g/l |
| NiCl₂•6 H₂O | 45 to 50 g/l |
| H₃BO₃ | 30 to 40 g/l. |

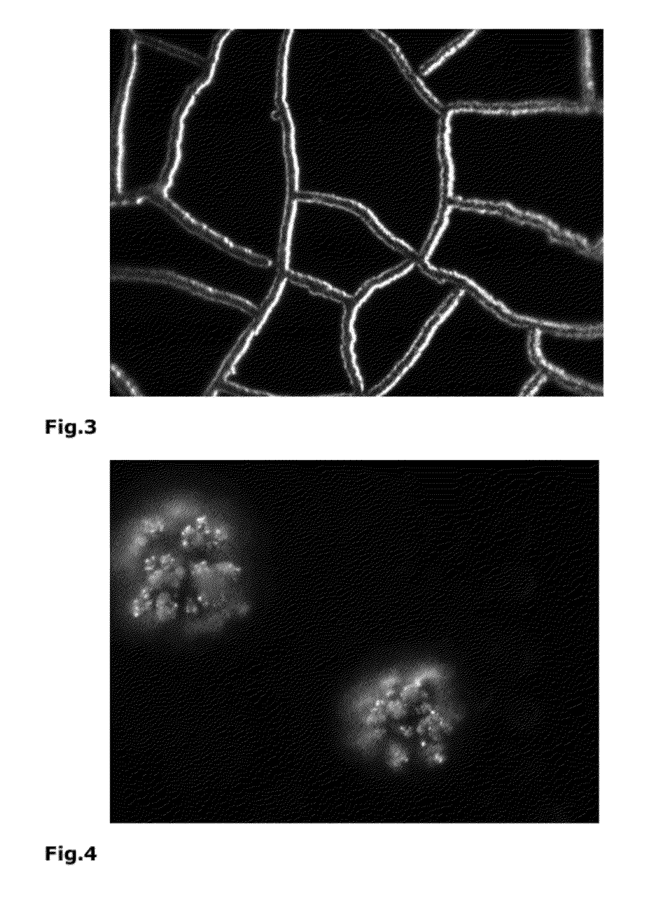

For corrosion protection in nickel layers, microcracked and microporous layers are essentially employed. In microcracked layers, voltages are generated by using organic acids when the nickel is deposited. A micrograph of such a layer is shown in FIG. 3. The cracks in the nickel layer are continued in the chromium deposited thereon. Corrosion attacks are thereby transmitted from the outer chromium layer to the inner nickel layer, and do not affect the surface.

In many fields, microporous layers have replaced the microcracked layers. In addition to sulfur compounds, solids are also employed in microporous layers, but excluding organic acids.

FIG. 4 shows a micrograph of a microporous layer.

Although numerous variants of nickel electrolytes are known, there is still a need for improved nickel electrolytes that yield coatings having changed or improved corrosion properties.

U.S. Pat. No. 3,471,271 describes a process in which cracks in the nickel layer are generated by adding large amounts of solids.

It was the object of the present invention to provide nickel electrolytes by means of which different, preferably improved, corrosion properties can be obtained.

This object is achieved by a nickel electrolyte containing:
nickel salts
organic acid
from 0.05 to 1 g/l of inorganic solid with a grain size (d50) of from 0.1 to 3 μm.

Suitable nickel compounds include various nickel salts, especially nickel chloride, nickel acetate, nickel sulfate, and mixtures thereof.

The content of nickel in the nickel electrolyte is preferably from 5 to 300 g/l, a content of from 200 to 280 g/l, each based on NiCl, being preferred.

Suitable organic acids include, in particular, low-molecular weight organic acids, such as formic acid, acetic acid, propionic acid, butyric acid, and mixtures thereof. Suitable amounts of the acid are about from 5 to 150 g/l, preferably from 10 to 30 g/l, or from 40 to 70 g/l.

Further, the nickel electrolyte according to the invention contains an inorganic solid, for example, aluminum oxide, silicon dioxide, silicates, such as talcum, silicon carbide, or mixtures thereof. Preferred contents of the inorganic solid are within a range of from 0.1 to 0.8 g/l, an amount of from 0.1 to 0.3 g/l being preferred.

Preferably, the nickel electrolyte contains more than 0.1 g/l, for example, 0.15 g/l or 0.2 g/l, of solid. Preferably, the nickel electrolyte contains less than 0.8 g/l or less than 0.7 g/l, more preferably less than 0.5 g/l, and even more preferably less than 0.4 g/l, or less than 0.3 g/l.

In some embodiments, the amount of inorganic solids may also be from 0.05 g/l to 100 g/l, or from 0.1 to 60 g/l. As the mean grain size of the inorganic solid (d50), preferably grain sizes of from 0.1 to 3 μm, more preferably from 0.8 to 3 μm, even more preferably from 1 to 2.2 μm are employed. In other embodiments, the mean grain size may be within a range of from 200 nm to 5 μm, or from 0.8 to 3 μm.

According to the invention, the electrolyte causes inorganic particles to be incorporated in the layer. A microcracked layer is formed that contains incorporated inorganic particles. The corresponding layers obtained have previously been unknown to the skilled person.

The nickel electrolyte may contain further usual ingredients of electrolytes, especially wetting agents, buffer substances, and/or brighteners.

In one embodiment, the nickel electrolyte additionally contains ammonia.

In one embodiment of the invention, the nickel electrolyte according to the invention contains no boric acid. Preferably, the content of boric acid is <10 g/l, more preferably <5 g/l, even more preferably <1 g/l.

Preferably, the nickel electrolyte according to the invention does not contain any reducing agent, such as hypophosphite, as employed for electroless plating. Preferably, the content of reducing agent is <10 g/l, more preferably <5 g/l, even more preferably <1 g/l.

A reducing agent is an agent capable of reducing Ni²⁺ in the electrolyte to form Ni.

The nickel electrolyte according to the invention is preferably adjusted to an acidic pH of from 1.5 to 6.5, more preferably from 2 to 5, and even more preferably from 3 to 4.5. This may be effected in the usual way, by adding acids or alkalis.

The invention also relates to a process for electroplating a component, comprising the step of contacting said component with the nickel electrolyte according to the invention and applying a current density of 2 to 15, preferably from 5 to 10, A/dm² at a temperature of from 20 to 55° C., preferably from 25 to 35° C.

According to the invention, a nickel electrolyte is employed that yields a microcracked structure even without the addition of a solid, irrespective of how the further treatment of the electrolyte is effected, for example, whether the further treatment of the layer is hot or cold rinsing. In accordance with this application, a nickel electrolyte is considered a microcracking nickel electrolyte if a cracked surface appears upon applying a current density of 5 A/dm² and a temperature of 25° C. for a layer thickness of 2 μm, followed by cold rinsing.

It has been found that, for a particularly good incorporation of a larger amount of solid particles, it is important that the nickel layer produced is thicker than the d50 value of the particles employed. The thicker the layers, the deeper and more firmly the solid appears to be incorporated. Layer thicknesses of more than 2 μm up to 5 μm are particularly preferred. The chromium layer thickness exhibits less influence. A chromium layer thickness within a range of about 0.375 to 2 μm are suitable.

When the process is performed, an influence of the agitation of the bath is seen. A slight agitation of the bath seems to be required in order to keep the inorganic solids dispersed in the nickel electrolyte. On the other hand, too vigorous an agitation seems to be detrimental, probably because particles are torn out of the cracks before they are sufficiently firmly bound.

Electroplating with nickel electrolytes is known to she skilled person in principle, and usual process measures for electroplating with nickel electrolytes can also be applied to the new electrolyte according to the invention.

By using the novel electrolyte, a specific structure is obtained that has defined pores and cracks. Surprisingly, this results in a significant change of the corrosion properties.

Typically, the component to be electroplated is made of plastic or metal. In a usual process, one or more copper layers are applied and then covered by one or more nickel layers and finally by decorative layers, for example, chromium layers. At least one of the nickel layers is a nickel layer according to the invention.

The nickel electrolyte according to the invention may advantageously be applied by usual electroplating plants, so that no construction work is necessary.

The invention further relates to a component comprising one or more layers obtainable by the process according to the invention.

The invention further relates to the use of the nickel electrolyte according to the invention for the coating of components.

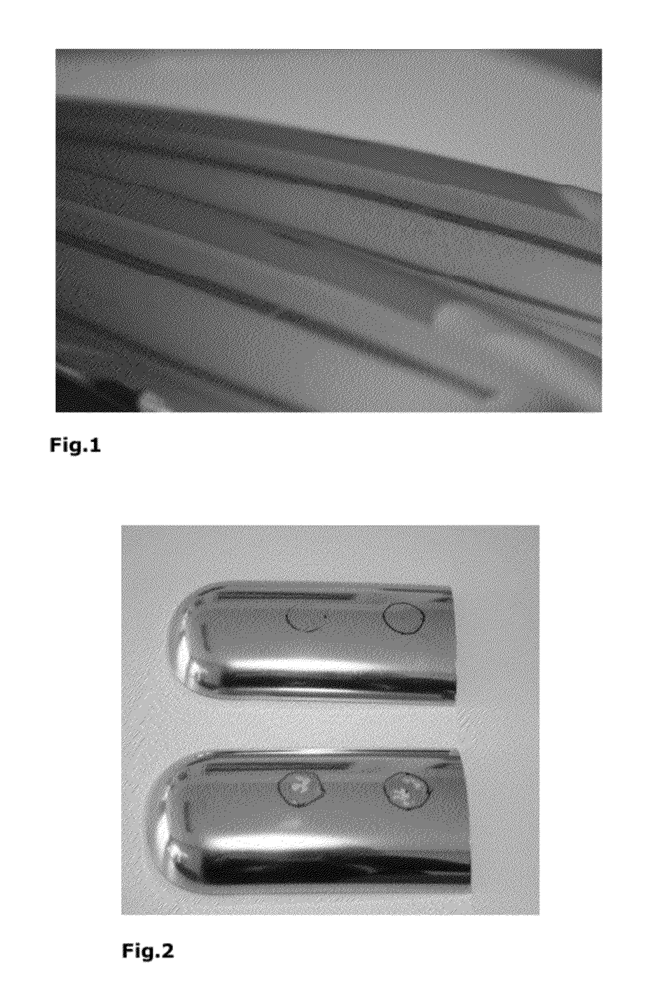

FIG. 1 shows the results of a CASS test with components that were coated according to Comparative Example 1 (rear) and Comparative Example 2 (front).

FIG. 2 shows results of a test against calcium chloride salts based on kaolin pastes. A component with a coating according to Example 2 (top) was compared with a coating according to Comparative Example 2 (bottom).

FIG. 3 shows a micrograph of a microcracked layer of the prior art.

FIG. 4 shows a microporous layer according to the prior art.

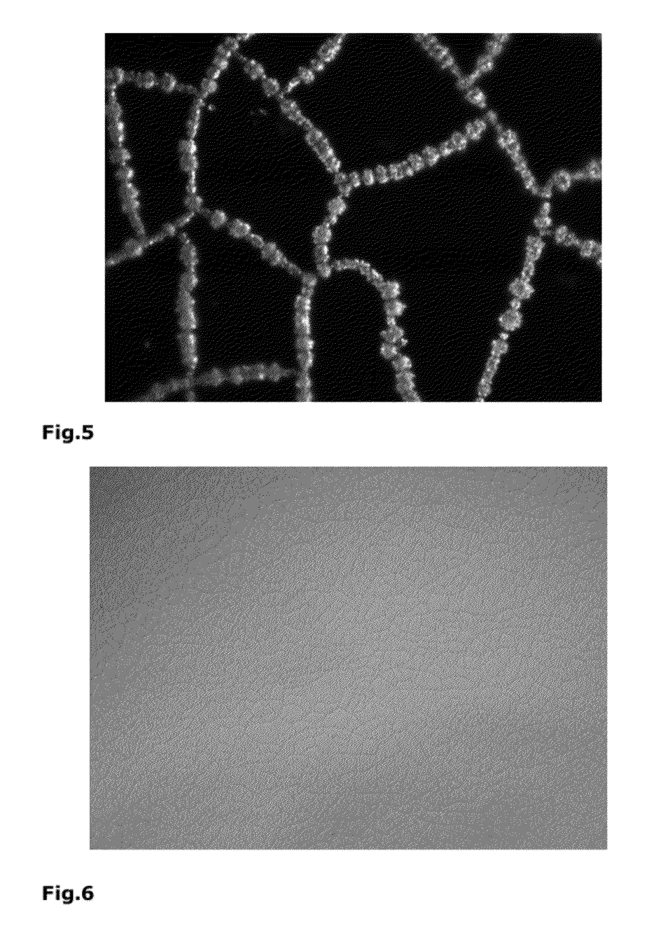

FIG. 5 shows a structure obtained with the nickel electrolyte according to the invention.

FIG. 6 shows a surface photograph obtained with the electrolyte according to the invention, but without the addition of an inorganic solid.

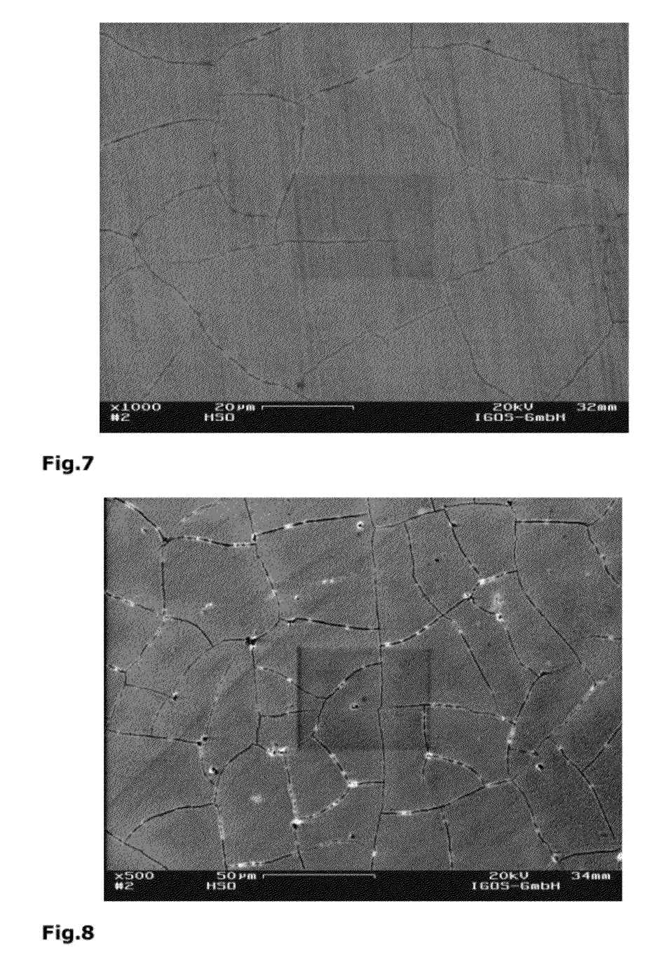

FIG. 7 shows a scanning-electron micrograph without solid of the surface according to FIG. 6.

FIG. 8 shows a scanning-electron micrograph of the layers according to the invention with incorporated solid.

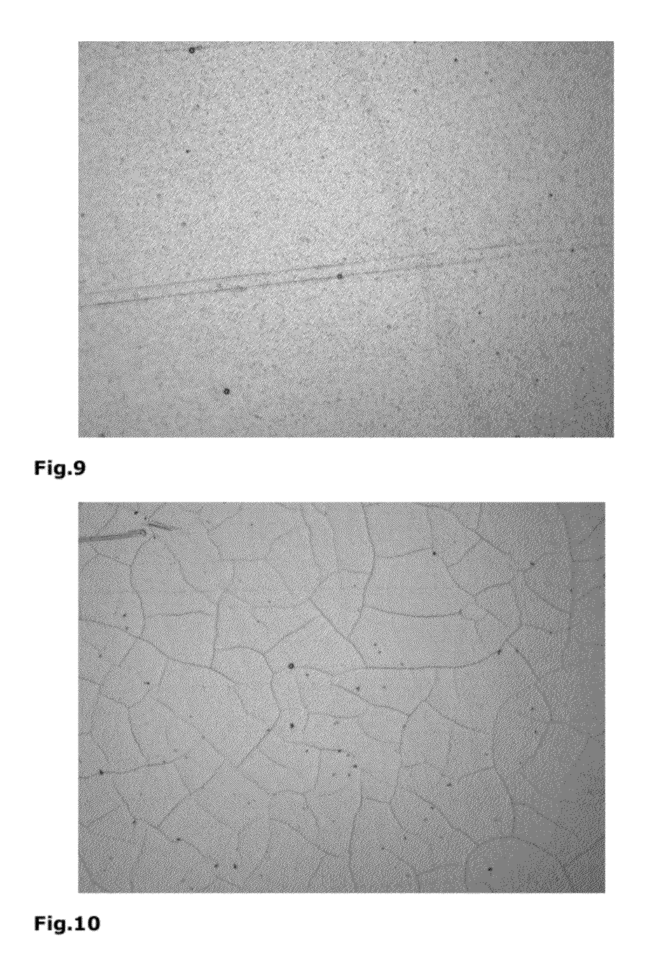

FIG. 9 shows a coating as obtained with an electrolyte of Example 1 of U.S. Pat. No. 3,471,271 (without the addition of a solid).

FIG. 10 shows the deposition of an electrolyte according to the invention according to Example 2 under identical conditions (without the addition of a solid).

Surprisingly, it is found that the layers according to the invention show an improved corrosion resistance, especially in the corrosion by calcium chloride as road salt. Calcium chloride has a lower dew point as compared to other salts and is extremely active because of its strongly hygroscopic behavior. The widely used microporous chromium coatings are often affected in a clearly visible way after one winter already.

The invention is further explained by means of the following Examples.

### EXAMPLE 1 (COMPARATIVE EXAMPLE)

Nickel sulfate: 240 g/l

Nickel chloride: 45 g/l

Boric acid: 30 g/l

Aluminum oxide, d50=2.5 μm: 0.3 g/l

Base brightener: 20 ml/l

Wetting agent: 10 ml/l

Brightener: 0.5 ml/l

Temperature: 55° C.

Current density: 4 A/dm²

pH value: 3.8

Exposure time: 3 min

Agitation by introducing air

The coating produced shows a solids-dependent microporous surface with at least 8000 pores/cm².

### EXAMPLE 2

Nickel chloride: 250 g/l

Ammonium acetate: 30 g/l

Ammonium chloride: 20 g/l

Acetic acid: 15 ml/l

Brightener: 1 ml/l

Aluminum oxide, d50=2 μm: 0.5 g/l

Temperature: 27° C.

Current density: 5 A/dm²

pH value: 3.5

Exposure time: 3 min

Agitation by introducing air

After the hot rinsing process, the coating shows a defined contiguous structural combination with an increased surface area and micropores.

### EXAMPLE 3

Nickel chloride: 180 g/l

Ammonium acetate: 30 g/l

Sodium chloride: 50 g/l

Acetic acid: 8 ml/l

Propionic acid: 5 ml/l

Brightener: 0.5 ml/l

Talcum+aluminum oxide, d50=3 μm: 0.7 g/l

Temperature: 30° C.

Current density: 6 A/dm²

pH value: 3.2

Exposure time: 3 min

Agitation by introducing air

After the hot rinsing process, the coating shows a defined contiguous structural combination with an increased surface area and micropores.

### EXAMPLE 4

Nickel chloride: 210 g/l

Nickel sulfate: 44 g/l

Ammonium acetate: 20 g/l

Ammonium formate: 10 g/l

Acetic acid: 10 ml/l

Brightener: 1.0 ml/l

Talcum+silicon dioxide, d50=1.5 μm: 0.6 g/l

Temperature: 29° C.

Current density: 5.5 A/dm²

pH value: 3.5

Exposure time: 3 min

Agitation by introducing air

After the hot rinsing process, the coating shows a defined contiguous structural combination with an increased surface area and micropores.

### EXAMPLE 5

### CASS Test

The CASS (copper accelerated acidic salt spray) test is described in DIN 50021. In a chamber, test specimens are sprayed with a salt solution having the following composition:
50 g/l sodium chloride
0.26 g/l Copper(II)) chloride•2 H₂O
acetic acid to adjust pH 3.1 to 3.3

After 24, 48 or 96 hours, the specimen is removed from the mist, thoroughly rinsed and dried. The dissolved copper salt causes the least noble metal in the layer system to dissolve.

The CASS test shows the corrosion path in the layer system.

### EXAMPLE 6

### Results of the CASS Tests

FIG. 1 shows the results of the CASS tests after 96 hours. In the rear component, which was coated according to Comparative Example 1, corrosion phenomena are to be seen, while the component with a coating according to Example 2 (front) shows no corrosion phenomena.

### EXAMPLE 7

### Calcium Chloride/Kaolin Test

A paste is prepared from 5 ml of saturated calcium chloride solution and 3 g of kaolin, having a pH of 6.5 to 7.5. A pasty substance is obtained. A defined amount thereof is applied to a specimen having a defined diameter, and stored at 60° C. for 48 hours. This is an accelerated test for estimating the resistance towards road salt containing calcium chloride.

### EXAMPLE 8

### Results of the Calcium Chloride/Kaolin Test

FIG. 2 shows that the component coated according to Comparative Example 1 (front) clearly shows corrosion traces, while the component coated according to the invention (rear) shows no signs of corrosion.

### EXAMPLE 9

A nickel electrolyte as described in Example 1 of U.S. Pat. No. 3,471,271 was coated at a current density of 6 A/dm² without adding a solid. FIG. 9 shows that the structure without an added solid does not show any cracks.

Under identical coating conditions, the electrolyte according to Example 2 was coated. FIG. 10 shows that this electrolyte yields cracked structures even without the addition of solids.

1. A nickel electrolyte comprising:
nickel salts
organic acid or salts thereof
from 0.05 to 1 g/l of inorganic solid with a grain size (d50) of from 0.1 to 3 μm.

2. The nickel electrolyte according to claim 1, wherein the content of nickel is from 5 to 300 g/l, preferably from 200 to 280 g/l, based on NiCl.

3. The nickel electrolyte according to claim 1, wherein said organic acid is selected from formic acid, acetic acid, propionic acid, butyric acid, and salts thereof and mixtures thereof, and/or that said organic acid is contained in an amount of from 5 to 150 g/l, preferably from 10 to 30 g/l, or from 40 to 70 g/l.

4. The nickel electrolyte according to claims 1, wherein said nickel electrolyte forms layers that contain microcracks, without the addition of inorganic solids.

5. The nickel electrolyte according to claim 1, wherein said inorganic solid is selected from aluminum oxide, silicon dioxide, silicates, such as talcum, silicon carbide, and mixtures thereof.

6. The nickel electrolyte according to claim 1, wherein its content of inorganic solid is from 0.1 g/l to 0.3 g/l.

7. The nickel electrolyte according to claim 1, wherein the average grain size of the inorganic solid (d50) is from 0.8 to 3 μm, preferably from 0.1 μm to 2.2 μm.

8. The nickel electrolyte according to claim 1, wherein one or more of the ingredients wetting agents, buffer substances, brighteners, ammonia, alkali compound, alkaline earth compound, ammonium compounds are contained therein.

9. The nickel electrolyte according to claim 1, wherein said nickel is introduced therein in the form of nickel chloride, nickel sulfate, nickel acetate, or mixtures thereof.

10. The nickel electrolyte according to claim 1, wherein its pH is from 1.5 to 6.5, preferably from 3 to 4.5.

11. The nickel electrolyte according to claim 1, wherein no reducing agent and/or no boric acid and/or no EDTA are contained therein.

12. A process for electroplating a component, comprising the step of contacting the component with a nickel electrolyte according to claim 1, and applying a current density of 2 to 15, preferably from 5 to 10, A/dm² at a temperature of from 20 to 55° C., preferably from 25 to 35° C.

13. The process according to claim 12, wherein one or more copper layers and optionally further nickel layers are applied to the component, and finally one or more cover layers, chromium layers are applied, and optionally a hot rinsing process is performed at least at 50° C.

14. A component comprising one or more layers, wherein at least one layer is obtainable by the process according to claim 12 and comprises inorganic solids.

15. A process comprising coating components with nickel electrolyte according to claim 1.
